(19) United States
(12) Patent Application Publication
(10) Pub. No.: US 2013/0330706 A1
(43) Pub. Date: Dec. 12, 2013

(54) Fluid for Suspended Animation

(71) Applicant: Evan C. Unger, Tucson, AZ (US)

(72) Inventor: Evan C. Unger, Tucson, AZ (US)

(21) Appl. No.: 13/912,047

(22) Filed: Jun. 6, 2013

Related U.S. Application Data
(60) Provisional application No. 61/656,442, filed on Jun. 6, 2012.

(51) Int. Cl. A01N 1/02

(52) U.S. Cl. CPC A01N 1/021
USPC 435/1.1

(57) ABSTRACT

A method to increase the time a donated organ will remain viable prior to transplantation, where the method includes infusing into a human patient declared brain dead, using a first intravenous line, a fluorocarbon fluid comprising a chain length from 1 to about 20 carbon atoms, and optionally synchronously with said infusing, exsanguinating said patient using a second intravenous line.

### CROSS REFERENCE TO RELATED APPLICATIONS

This Application claims priority from a United States Provisional Application filed Jun. 6, 2012, and having Ser. No. 61/656,442.

### FIELD OF THE INVENTION

The invention relates to a fluid for suspended animation.

### BACKGROUND OF THE INVENTION

Often, solid-organ transplantations are performed as the therapeutic option of choice. In many cases, transplantation offers definitive treatment for a given disease entity. As a result, the list of indications for solid-organ transplantation has expanded considerably, placing increasing pressure on an already limited supply of donor organs.

The growth in the number of patients wanting or waiting for a transplant has outpaced the supply of available organs. Each year, more patients are placed on the waiting lists than receive transplants, causing the waiting time to increase. With such constraints, preservation of organs for transport between centers becomes crucial.

What is needed is an improved organ-preservation solution to provide improved organ storage and outcomes.

### SUMMARY OF THE INVENTION

A new composition for preserving kidneys, hearts, and other organs later used for transplantation. Applicant's fluid for suspended animation decreases damage to organs, and thus prolongs the time a donated organ will remain viable prior to transplantation. This could increase the number of available organs for potential recipients

### DETAILED DESCRIPTION OF PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Applicant's fluid for suspended animation comprises one or more fluorocarbon materials, osmotic agent(s), pH agent(s), such as a buffer, nutritional agent(s), for example sugars, amino acids and fatty acids, and optionally one or more anti-oxidants e.g. glutathione, vitamin A, and vitamin E. Applicant's fluid for suspended animation is administered into a subject, usually intravenously, after the brain is determined to be dead to replace the blood in the subject.

As the blood is removed, the vascular volume is preferably maintained in notate of constancy, with the end result that Applicant's fluid for suspended animation has replaced essentially the entire vascular volume. During the period of replacement of vascular volume, the subject may be ventilated with room air, oxygen or a mixture of gases, including carbon dioxide, nitrogen and halogenated gases.

In certain embodiments, the fluorocarbon comprises any fluorocarbon material with carbon chain lengths from 1 to 20 carbon chain lengths but more preferably is from 4 to 12 carbon atoms in length; the number of fluorine atoms may vary from about 4 to about 26 fluorine atoms with the remaining atoms comprising oxygen, bromine, hydrogen and chlorine.

In certain embodiments, the fluorocarbon comprises dodecafluoro-pentane (DDFP). Exemplary fluorocarbons for use in the present invention include, for example, hexafluoroacetone, 1,3-dichlorotetrafluoroacetone, tetrafluoroallene, boron trifluoride, 1,2,3-trichloro-2-fluoro-1,3-butadiene, hexafluoro-1,3-butadiene, 1-fluorobutane, perfluorobutane, decafluorobutane, perfluoro-1-butene, perfluoro-2-butene, 2-chloro-1,1,1,4,4,4-hexafluorobutyne, 2-chloro-1,1,1,4,4,4-hexafluoro-2-butene, perfluoro-2-butyne, octafluorocyclobutane, perfluorocyclobutene, perfluorocyclobutane, perfluorocyclopentane, octafluorocyclopentene, perfluorocyclopropane, 1,1,1-trifluorodiazoethane, hexafluorodimethylamine, perfluoroethane, perfluoropropane, perfluoropentane, hexafluoroethane, hexafluoropropylene, 1,1,2,2,3,3,4,4-octafluorobutane, 1,1,1,3,3-pentafluorobutane, octafluoropropane, octafluorocyclopentene, 1,1-dichlorofluoroethane, hexafluoro-2-butyne, octafluoro-2-butene, hexafluorobuta-1,3-diene, perfluorodimethylamine, 4-methyl-1,1,1,2-tetrafluoroethane, 1,1,1-trifluoroethane, 1,1,2,2-tetrafluoroethane, 1,1,2-trichloro-1,2,2-trifluoroethane, 1,1,1-trichloro-2,2,2-trifluoroethane, 1,1-dichloro-1,2-difluoroethylene, 1,1-dichloro-1,2,2,2-tetrafluoroethane, 1-chloro-1,1,2,2,2-pentafluoroethane, 1,1-difluoro-2-chloroethane, 1,1-dichloro-2-fluoroethane, dichloro-1,1,2,2-tetrafluoroethane, 1-chloro-1,1,2,2-tetrafluoroethane, 2-chloro-1,1-difluoroethane, 1,1,2-trifluoro-2-chloroethane, 1,2-difluorochloroethane, chloropentafluoroethane, dichlorotrifluoroethane, fluoroethane, nitropentafluoroethane, nitrosopentafluoroethane, perfluoroethylamine, 1,2-dichloro-2,2-difluoroethane, 1,1-dichloro-1,2-difluoroethane, 1,2-dichloro-1,1,3-trifluoropropane, 1,2-difluoroethane, 1,2-difluoroethylene, trifluoromethanesulfonylchloride, trifluoromethanesulfenylchloride, (pentafluorothio)trifluoromethane, trifluoromethanesulfonylfluoride, bromodifluoronitrosomethane, bromofluoromethane, bromochlorodifluoromethane, bromochlorofluoromethane, bromotrifluoromethane, bromotrifluoroethane, chlorodifluoronitromethane, chlorofluoromethane, chlorotrifluoromethane, chlorodifluoromethane, dibromofluoromethane, dibromodifluoromethane, dichlorodifluoromethane, dichlorofluoromethane, 1-bromoperfluorobutane, difluoromethane, difluoroiodomethane, fluoromethane, perfluoromethane, iodotrifluoromethane, iodotrifluoroethylene, nitrotrifluoromethane, nitrosotrifluoromethane, tetrafluoromethane, trichlorofluoromethane, trifluoromethane, perfluoropent-1-ene, 1,1,1,2,2,3-hexafluoropropane, heptafluoropropane, 1,1,1,2,3,3,3-heptafluoropropane, 1,1,2,2,3,3,3-heptafluoropropane, 2,2-difluoropropane, heptafluoro-1-nitropropane, heptafluoro-1-nitrosopropane, heptafluoro-2-iodopropane, perfluoropropane, hexafluoropropane, 1,1,1,2,3,3-hexafluoro-2,3-dichloropropane, 1-bromo-1,1,2,3,3,3-hexafluoropropane, 1-bromoperfluoropropane, 2-chloropentafluoro-1,3-butadiene, 3-fluoropropane, 3-fluoropropylene, perfluoropropylene, perfluorotetrahydropyran, perfluoromethyltetrahydrofuran, perfluorobutylmethyl ether, perfluoromethyl-n-butyl ether, perfluoromethylisopropyl ether, perfluoromethyl-t-butyl ether, perfluorobutyl ethyl ether, perfluoromethylpentyl ether, 3,3,3-trifluoropropyne, 3-fluorostyrene, sulfur (di)-decafluoride (S₂ F₁₀), sulfur hexafluoride, selenium hexafluoride, trifluoroacetonitrile, trifluoromethyl peroxide, trifluoromethyl sulfide, tungsten hexafluoride, 1-bromo-nonafluorobutane, 1-chloro-1-fluoro-1-bromomethane, 1-bromo-2,4-difluorobenzene, 2-iodo-1,1,1-trifluoroethane, bromine pentafluoride, perfluoro-2-methyl-2-pentene, 1,1,1,3,3-pentafluoropentane, 3-fluorobenzaldehyde, 2-fluoro-5-nitrotoluene, 3-fluorostyrene, 3,5-difluoroaniline, 2,2,2-trifluoroethylacrylate, 3-(trifluoromethoxy)-acetophenone, bis(perfluoroisopropyl) ether, bis(perfluoropropyl) ether, perfluoro isobutyl methyl ether, perfluoro n-propyl ethyl ether, perfluoro cyclobutyl methyl ether, perfluoro cyclopropyl ethyl ether, perfluoro isopropyl methyl ether, perfluoro n-propyl methyl ether, perfluorodiethyl ether, perfluoro cyclopropyl methyl ether, perfluoro methyl ethyl ether, perfluoro dimethyl ether and mixtures thereof.

The fluorocarbon is stabilized in emulsion or bubbles. The stabilizing agent comprises a surfactant that may in turn comprise fluorosurfactant or phospholipid.

Applicant's fluid for suspended animation is free of not only Red Blood Cells, but also White Blood Cells.

The following Examples are presented to further illustrate to persons skilled in the art how to make and use the invention. These Examples are not intended as a limitation, however, upon the scope of the invention.

### EXAMPLE 1

A soldier is in combat and suffers a devastating head injury. The patient's ocular reflexes show no response to light. EEG shows no brain activity. Medical diagnosis of cerebral death is made. Applicant's fluid for suspended animation comprising one or more fluorocarbons/osmotic/nutritional/antioxidant, buffered at pH 7.2, is infused while the donor is exsanguinated. Those skilled in the art will appreciate that two or more IV lines are used. The donor is ventilated and perfusion and oxygenation are maintained.

The organs are ultimately harvested from the donor and deployed in transplants to aid soldiers or other casualty victims in need of transplanted organs, limbs and other tissues.

### EXAMPLE 2

Pre-conditioning With DDFPe Without Exsanguination.

A motorcycle trauma victim is declared brain dead. A decision is made to terminate life-support and donate organs. DDFPe (2% w/vol) is infused IV over 30 minutes at a dose of 0.6 cc per kg. Life support is terminated after the infusion and the organs (liver, kidneys, spleen, heart, lungs, pancreas, etc.) are then harvested. The degree of damage to the organs is decreased by about 50% by infusing DDFPe prior to organ harvesting compared to control and the shelf life of the organs pre-conditioned with DDFPe is increased.

### EXAMPLE 3

Flushing organs ex vivo with DDFPe

The kidneys, liver, pancreas and other organs are harvested from a brain dead donor.

After removal from the body each organ is flushed with an aqueous solution of Table 1 mixed with 2% w/vol DDFPe. After flushing with the chilled solution the organs can be stored between temperatures ranging from 2 to 25° C.

TABLE 1

| | | |
|---|---|---|
| | NOMINAL LEVEL | HUMAN SERUM |
| COMPONENT | mmol/L | mmol/L |

| Sodium ions | 135 | | 131-148 | |
|---|---|---|---|---|
| Potassium ions | 5.0 | | 3.4-5.2 | |
| Calcium ions | 1.25 | | 1.12-1.46 | |
| Magnesium Ions | 0.45 | | 0.38-0.72 | |
| Chloride Ions | 119 | | 101-111 | |
| Bicarbonate ions | 25 | | 21-29 | |
| Organic acid | 5 (BES) | | 6.4 (Imidazole) | |
| Glucose | 10 | | 3.6-6.1 | |
| Glycerol | 0.11 | | 0.131 | |
| Glutamate | 300 | | 20-110 | |
| Glutamine | 400 | | 140-570 | |
| Aspartate | 20 | μmols/L | 1-11 | μmols/L |
| Carnitine | 50 | μmols/L | 35-85 | μmols/L |
| Choline | 10 | μmols/L | 18-70 | μmols/L |
| Thiamine | 40 | nmols/L | 6-135 | nmols/L |
| Pyrophosphate | | | | |
| Human insulin | 28 | mIU/L | 6-35 | mIU/L |

| | | |
|---|---|---|
| pH @ 37° C. | 7.30-7.46 | 7.32-7.45 |
| Osmolality | 265-286 | 264-290 |
| (mOsm/kg) | | |

### EXAMPLE 4

Preparation of DDFPe With Different Organ Preservation Solutions

DDFPe is mixed with an aqueous solution having an osmolality of 320 mmol/kg and pH 7.4 at room temperature, and comprising: Potassium 135 mmol/L, Sodium 35 mmol/L, Magnesium 5 mmol/L, Lactobionate 100 mmol/L, Phosphate 25 mmol/L, Sulphate 5 mmol/L, Raffinose 30 mmol/L, Adenosine 5 mmol/L, Allopurinol 1 mmol/L, Glutathione 3 mmol/L, Insulin 100 U/L, Dexamethasone 8 mg/L, Hydroxyethyl starch (HES) 50 g/L and Bactrim 0.5 ml/L. In certain embodiments, lactobionate is substituted for HES.

### EXAMPLE 5

DDFPe is mixed with an aqueous solution comprising: Sodium 100 mmol/L, Potassium 15 mmol/L, Magnesium 13 mmol/L, Calcium 0.25 mmol/L, Lactobionate 80 mmol/L, Glutathione 3 mmol/L, Glutamate 20 mmol/L, Mannitol 60 mmol/L, Histidine 30 mmol/L.

### EXAMPLE 6

DDFPe is mixed 2% w/vol. with an aqueous solution comprising: Sodium 100 mmol/L, Potassium 44 mmol/L, Phosphate 25 mmol/L, Trehalose 41 mmol/L, HES 30 gm/L, Gluconate 100 mmol/L.

The solutions of Examples 4, 5, and 6, may be used as described hereinabove for flushing and cold preservation of organs prior to transplantation.

The solutions of Examples 3, 4, 5, and 6, may be used to perfuse organs ex vivo prior to transplantation. For continuous perfusion however, gluconate is used in place of lactobionic acid.

### EXAMPLE 7

Oxygen Persufflation With Solution Containing DDFPe.

A solution containing DDFPe. 2% w/vol is mixed with the solution of Table 1. The chilled mixture is nebulized with 100% O₂. The oxygen saturated solution is used to persufflate the portal vein of a liver prior to cold storage. Compared to standard persufflation with O₂ alone there is significant reduction of parenchymal liver enzyme (ALT) and mitochondrial GLDH enzyme release during reperfusion with the solution containing DDFPe. 2% w/vol mixed with the solution of Table 1. Moreover, Kupffer cell activation, as evaluated from acid phosphatase activity in the perfusate is reduced. Electron microscopic analysis revealed that the liver mitochondria and sinusoidal endothelial lining were better preserved after oxygen persufflation with a solution containing DDFPe. 2% w/vol mixed with the solution of Table 1.

The outcomes of the transplants from tissues derived from donors subjected to

Applicant's fluid for suspended animation are superior to the outcomes for transplants from patients without Applicant's fluid for suspended animation suspended animation. Long-term rejection of the grafts is less from donors administered Applicant's fluid for suspended animation and there is improved graft survival.

While the preferred embodiments of the present invention have been illustrated in detail, it should be apparent that modifications and adaptations to those embodiments may occur to one skilled in the art without departing from the scope of the present invention as set forth herein.

1. A method to increase the time one or more donated organs will remain viable prior to transplantation, comprising:
after a decision is made to terminate life-support for a human patient declared brain dead, infusing using a first intravenous line said patient with a fluorocarbon fluid comprising a chain length from 1 to about 20 carbon atoms; and
harvesting said one or more organs.

2. The method of claim 1, further comprising synchronously with said infusing, exsanguinating said patient using a second intravenous line.

3. The method of claim 2, further comprising synchronously with said infusing and said exsanguinating, ventilating said patient with oxygen.

4. The method of claim 1, further comprising nebulizing said fluorocarbon fluid with 100 percent oxygen prior to said infusing.

5. The method of claim 1, wherein said fluorocarbon fluid comprises dodecafluoropentane.

6. The method of claim 1, further comprising:
prior to said infusing, forming a composition comprising said fluorocarbon fluid in combination with an aqueous solution comprising sodium ions, potassium ions, calcium ions and magnesium ions.

7. The method of claim 6, wherein said aqueous solution further comprises chloride ions and bicarbonate ions.

8. The method of claim 6, wherein said aqueous solution further comprises one or more saccharides.

9. The method of claim 6, wherein said aqueous solution further comprises one or more amino acids or salts thereof.

10. The method of claim 6, wherein said aqueous solution further comprises one or more vitamins.

11. The method of claim 6, wherein said aqueous solution further comprises insulin.

12. A method to increase the time one or more donated organs will remain viable prior to transplantation, comprising:
flushing organs harvested from a donor with a fluorocarbon fluid comprising a chain length from 1 to about 20 carbon atoms;
after said flushing, storing said one or more organs at a temperature between about 2 ° C. to about 25 ° C.

13. The method of claim 12, wherein said fluorocarbon fluid comprises dodecafluoropentane.

14. The method of claim 12, further comprising:
prior to said flushing, forming a composition comprising said fluorocarbon fluid in combination with an aqueous solution comprising sodium ions, potassium ions, calcium ions and magnesium ions.

15. The method of claim 14, wherein said aqueous solution further comprises chloride ions and bicarbonate ions.

16. The method of claim 15, wherein said aqueous solution further comprises one or more saccharides.

17. A composition for flushing one or more donated organs to enhance the time said one or more donated organs will remain viable prior to transplantation, comprising a fluorocarbon fluid comprising a chain length from 1 to about 20 carbon atoms.

18. The composition of claim 17, wherein said fluorocarbon fluid comprises dodecafluoro-pentane.

19. The composition of claim 18, further comprising sodium ions, potassium ions, calcium ions and magnesium ions.

20. The composition of claim 19, further comprising chloride ions and bicarbonate ions.

21. The composition of claim 20, further comprising one or more saccharides.
